(19) United States
(12) Patent Application Publication
(10) Pub. No.: US 2008/0030807 A1
(43) Pub. Date: Feb. 7, 2008

(54) Scanning device and method for calibration using single-point data

(75) Inventor: Yen-Cheng Chen, (US)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/878,562

(22) Filed: Jul. 25, 2007

(30) Foreign Application Priority Data
Aug. 1, 2006 (TW) 095128068

(51) Int. Cl. H04N 1/04

(52) U.S. Cl. 358/494

(57) ABSTRACT

A scanning device for calibration using single-point data includes a light source module, a scanning module, a non-volatile memory and a processor. The light source module provides a linear illumination extending along an X-axis to illuminate an original and a calibration sheet. The scanning module scans lines of the original to generate an original image signal. Each line extends along the X-axis. The scanning module further scans the calibration sheet to generate a standard image signal. The non-volatile memory stores a calibration database recording data for deriving respective luminance of the linear illumination along the X-axis correspondent to luminance of a specific point of the linear illumination. The processor receives the standard image signal and the original image signal and converts the original image signal into a digital output signal with respect to the standard image signal and the calibration database.

### BACKGROUND OF THE INVENTION

1. Field of Invention

The invention relates to a scanning device and a scanning method, and more particularly to a scanning device and a scanning method for calibration using single-point data.

2. Related Art

A conventional contact image sensor (CIS) scanner calibrates a scanned image of a document according to a stored scanned result, which is obtained by scanning a white sheet or a calibration sheet.

However, the light emission of the light source of the CIS scanner tends to attenuate as the time elapses. Even though the attenuation of the light source is not great in amount, the attenuation still cannot satisfy the user who wishes to obtain the enhanced scan quality.

In the application of a flatbed scanner, the calibration sheet may be fixed inside a housing of the scanner and disposed in parallel to an original, so the calibration sheet and the original may be scanned without interference. In the application of a sheet-fed scanner, the calibration sheet cannot be remained stationary in the scan window to prevent the original from being blocked. Thus, the calibration sheet has to be movable, and a complicated driving mechanism has to be utilized.

Thus, it is an important problem to be solved in this invention to provide a simple calibration method suitable for both a flatbed scanner and a sheet-fed scanner.

### SUMMARY OF THE INVENTION

It is therefore an object of the invention to provide a scanning device for performing calibration according to single-point data and thus satisfying applications to a flatbed scanner and a sheet-fed scanner, and a scanning method thereof.

To achieve the above-identified object, the invention provides a scanning device including a light source module, a scanning module, a non-volatile memory and a processor. The light source module provides a linear illumination extending along an X-axis to illuminate an original and a calibration sheet. The scanning module scans a plurality of lines of the original to generate an original image signal. Each line extends along the X-axis. The scanning module further scans the calibration sheet to generate a standard image signal. The non-volatile memory stores a calibration database, which records data for deriving respective luminance of the linear illumination along the X-axis correspondent to luminance of a specific point of the linear illumination. The processor receives the standard image signal and the original image signal, and converts the original image signal into a digital output signal with respect to the standard image signal and the calibration database.

The invention also provides a scanning method for calibration using single-point data. The method includes the steps of: scanning, by a scanning module, a calibration sheet through a linear illumination to generate a standard image signal; scanning, by the scanning module, a plurality of lines of an original through the linear illumination to generate an original image signal, each line extending along an X-axis; and converting the original image signal into a digital output signal with respect to the standard image signal and a calibration database. The calibration database stores relationships between luminance of a plurality of reference points of the linear illumination and luminance of a specific point of the linear illumination.

Thus, the calibration sheet has a length along the X-axis, and the length is shorter than a maximum scan width of the scanning module.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a relationship between a position and luminance in a light source module according to the invention;

FIG. 2 is a schematic block diagram showing a scanning device according to a first embodiment of the invention;

FIG. 3 is a top view showing the scanning device according to the first embodiment of the invention; and

FIG. 4 is a schematic illustration showing a scanning device according to a second embodiment of the invention.

### DETAILED DESCRIPTION OF THE INVENTION

The present invention will be apparent from the following detailed description, which proceeds with reference to the accompanying drawings, wherein the same references relate to the same elements.

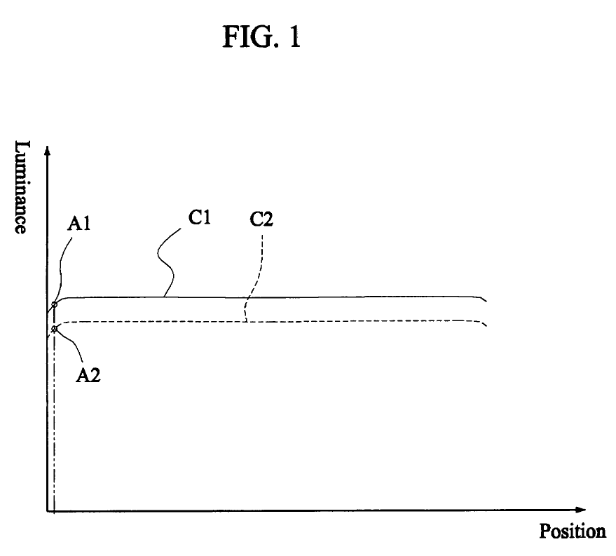

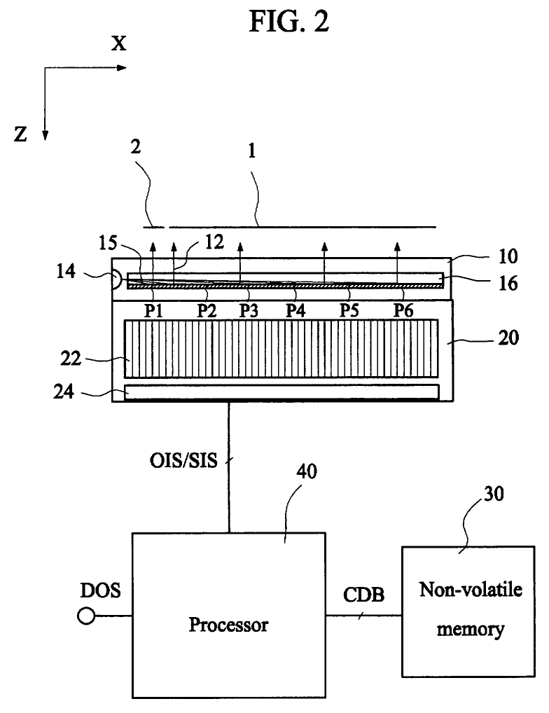

FIG. 1 shows a relationship between a position and luminance of a light source module according to the invention. FIG. 2 is a schematic block diagram showing a scanning device according to a first embodiment of the invention. As shown in FIG. 1, the horizontal axis represents the positions along the X-axis of FIG. 2, and the vertical axis represents the luminance. The present inventor has discovered that an initial relationship between the positions and the luminance of the light source module 10 can be represented by the curve C1 according to the theoretical conclusion and the experimental verification. The relationship between the position and the luminance, after the light source module is used for a certain period of time, is represented by the curve C2, which shows the luminance of the entire light source module 10 decreases. This represents that the luminance attenuation of a linear illumination has nothing to do with the positions along the X-axis. Theoretically speaking, the property of a light-guiding rod 16 in the light source module 10, which includes a point light source 14 and the light-guiding rod 16, does not alter as the time elapses, and only the luminance of the point light source 14 changes as the time elapses. The light-guiding rod 16 transmits and scatters a point light illumination 15 into a linear light illumination 12, and the property of the light-guiding rod 16 is fixed before it is shipped out. Thus, the only variable is the luminance attenuation of the point light source, and the distance from the point light source in the lengthwise direction (X-axis) of the light-guiding rod 16 does not pose as a factor to the variance in the luminance attenuation. Thus, the data of all points on the curve C1 can be derived if the data of point A1 can be obtained, and the data of all points on the curve C2 can be derived as long as the data of point A2 can be obtained. Thus, by employing this particular characteristic of the light source module for the scanning device, the present invention provides a method for calibration using single-point data.

Referring to FIG. 2, the scanning device of this embodiment includes the light source module 10, a scanning module 20, a non-volatile memory 30 and a processor 40. The light source module 10 provides the linear illumination 12 extending along the X-axis to illuminate an original 1 and a calibration sheet 2. A length of the calibration sheet 2 along the X-axis is shorter than a maximum scan width of the scanning module 20. In this embodiment, a portion of the scanning module 20 for scanning the original 1 and another portion of the scanning module 20 for scanning the calibration sheet 2 do not overlap. In another embodiment, however, a portion of the scanning module 20 for scanning the original 1 and another portion of the scanning module 20 for scanning the calibration sheet 2 may overlap.

As mentioned hereinabove, the light source module 10 includes the point light source 14 and the light-guiding rod 16. The point light source 14, such as a light emitting diode (LED), outputs the point light illumination 15. The light-guiding rod 16 extends along the X-axis and transmits the point illumination in a direction perpendicular to the X-axis and along the X-axis to provide the linear illumination.

The scanning module 20 scans a plurality of lines of the original 1 to generate an original image signal OIS, wherein each line extends along the X-axis. The scanning module 20 further scans the calibration sheet 2 to generate a standard image signal SIS. For example, the scanning module 20 includes a plurality of rod lenses 22 arranged in a row, and an image sensor 24.

In this embodiment, the scanning module 20 and the light source module 10 constitute two parts of the conventional contact image sensor (CIS) scanning module.

The non-volatile memory 30 stores a calibration database CDB, which records data for deriving respective luminance of the linear illumination 12 along the X-axis correspondent to luminance of a specific point of the linear illumination 12, that is, the relationships between luminance of a plurality of reference points P2 to P6 of the linear illumination 12 and the luminance of a specific point P1 of the linear illumination 12. The information recorded in the calibration database CDB may be a function or a look-up table.

The processor 40 receives the standard image signal SIS and the original image signal OIS, and converts the original image signal OIS into a digital output signal DOS with respect to the standard image signal SIS and the calibration database CDB.

According to FIG. 1, the luminance data at all positions can be derived as long as the luminance data at one position can be obtained. So, the original image signal OIS may be an image signal corresponding to one pixel.

In this embodiment, the calibration sheet 2 and the original 1 are located on the same plane. In another embodiment, however, the calibration sheet 2 and the original 1 may also be located on different planes. That is, the calibration sheet 2 is separated from the original 1 by a distance in the Z-axis direction. The luminance is inversely proportional to a square of the distance, so the processor 40 can convert the original image signal OIS into the digital output signal DOS with respect to the standard image signal SIS, the calibration database CDB and the distance.

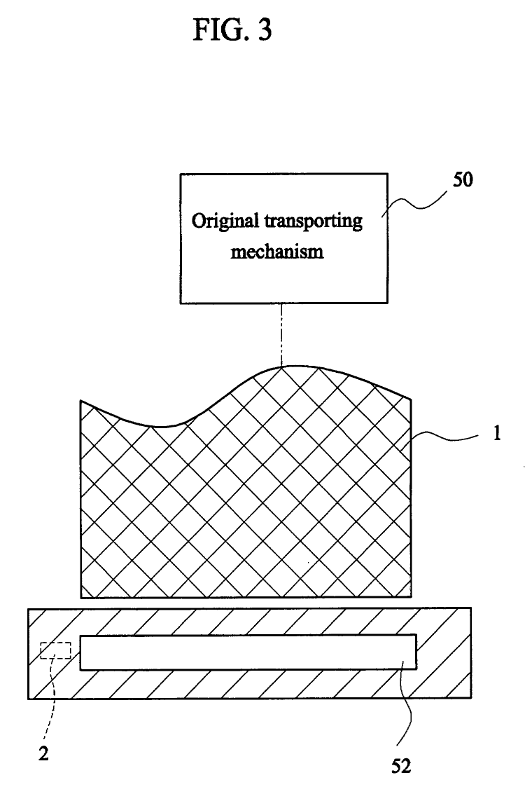

FIG. 3 is a top view showing the scanning device according to the first embodiment of the invention. Referring to FIG. 3, the scanning device further includes an original transporting mechanism 50 for feeding the original 1 across a scan window 52, in which the scanning module 20 scans the original 1. In this embodiment, the calibration sheet 2 is located outside the scan window 52, so the calibration sheet 2 does not block the scan window 52.

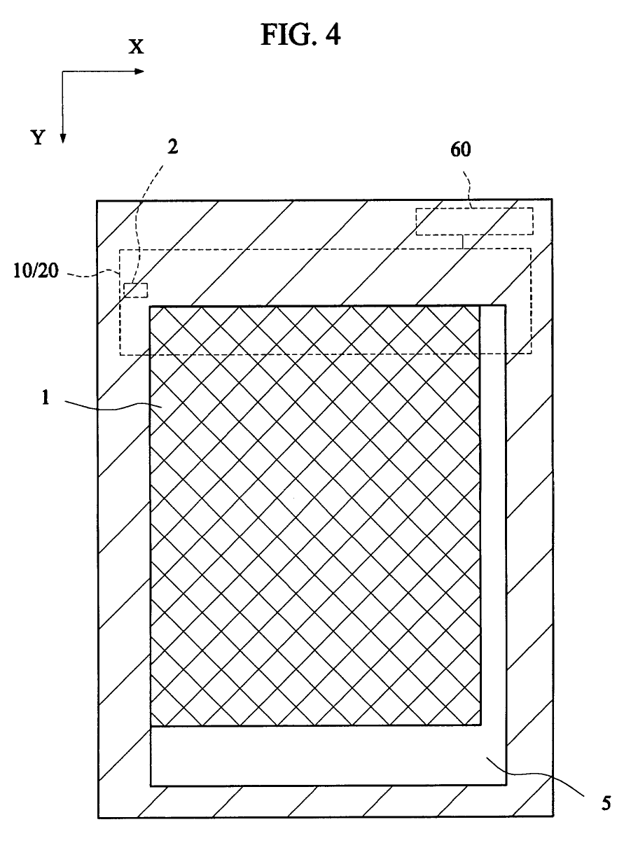

FIG. 4 is a schematic illustration showing a scanning device according to a second embodiment of the invention. As shown in FIGS. 4 to 2, this embodiment differs from the first embodiment in that the scanner of the second embodiment is a flatbed scanner. Thus, the scanning device further includes a scanning module moving mechanism 60 for moving the scanning module 20 to scan the original 1 placed on a scan platen 5. The calibration sheet 2 may be located at the position shown in the drawing, or may be shifted by a distance toward the X-axis. Alternatively, the length of the calibration sheet 2 may be greater than or equal to the length of the scanning module, but the scanning module only has to scan a portion of the calibration sheet.

In addition, the invention also provides a scanning method for calibration using the single-point data. The method includes the following steps.

First, the scanning module 20 scans the calibration sheet 2 with the linear illumination 12 to obtain the standard image signal SIS. Then, the original 1 is transported across the scan window 52 or the scanning module 20 is moved while the scanning module 20 scans the lines of the original 1 with the linear illumination 12 to generate the original image signal OIS, wherein each line extends along the X-axis. Next, the original image signal OIS is converted into the digital output signal DOS with respect to the standard image signal SIS and the calibration database CDB. The calibration database CDB stores data for deriving respective luminance of the linear illumination 12 along the X-axis correspondent to luminance of a specific point of the linear illumination 12, that is, the relationships between the luminance of the plurality of reference points P2 to P6 of the linear illumination 12 and the luminance of the specific point P1 of the linear illumination 12.

According to the scanning device and the scanning method of the invention, the calibration reference for the whole scan line can be obtained according to the data corresponding to a single point on the calibration sheet. Thus, the size of the calibration sheet can be reduced, and the calibration sheet can be arranged to satisfy the applications to both the flatbed and sheet-fed scanners.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A scanning device comprising:
a light source module for providing a linear illumination extending along an X-axis to illuminate an original and a calibration sheet;
a scanning module for scanning a plurality of lines of the original to generate an original image signal, and scanning the calibration sheet to generate a standard image signal, each of the lines extending along the X-axis;
a non-volatile memory for storing a calibration database, which records data for deriving respective luminance of the linear illumination along the X-axis correspondent to luminance of a specific point of the linear illumination; and
a processor for receiving the standard image signal and the original image signal, and converting the original image signal into a digital output signal with respect to the standard image signal and the calibration database.

2. The device according to claim 1, wherein the light source module comprises:
a point light source for outputting a point illumination; and
a light-guiding rod, extending along the X-axis, for transmitting the point illumination in a direction perpendicular to the X-axis and along the X-axis to provide the linear illumination.

3. The device according to claim 2, wherein the point light source is a light emitting diode (LED).

4. The device according to claim 1, wherein the scanning module and the linear light source module constitute two parts of a contact image sensor (CIS) scanning module.

5. The device according to claim 1, wherein a length of the calibration sheet along the X-axis is shorter than a maximum scan width of the scanning module.

6. The device according to claim 1, wherein the original image signal is an image signal corresponding to one pixel.

7. The device according to claim 1, wherein a portion of the scanning module for scanning the original and another portion of the scanning module for scanning the calibration sheet do not overlap.

8. The device according to claim 1, further comprising:
an original transporting mechanism for transporting the original across a scan window, in which the scanning module scans the original.

9. The device according to claim 8, wherein the calibration sheet is located outside the scan window.

10. The device according to claim 1, further comprising:
a scanning module moving mechanism for moving the scanning module to scan the original.

11. The device according to claim 1, wherein the calibration database comprises one of a function and a look-up table.

12. The device according to claim 1, wherein the calibration sheet and the original are located on different planes.

13. A scanning method for calibration using single-point data, the method comprising the steps of:
scanning, by a scanning module, a calibration sheet with a linear illumination to generate a standard image signal;
scanning, by the scanning module, a plurality of lines of an original with the linear illumination to generate an original image signal, each of the lines extending along an X-axis; and
converting the original image signal into a digital output signal with respect to the standard image signal and a calibration database, wherein the calibration database stores data for deriving respective luminance of the linear illumination along the X-axis correspondent to luminance of a specific point of the linear illumination.

14. The method according to claim 13, wherein a length of the calibration sheet along the X-axis is shorter than a maximum scan width of the scanning module.

15. The method according to claim 13, wherein the original image signal is an image signal corresponding to one pixel.

16. The method according to claim 13, wherein a portion of the scanning module for scanning the original and another portion of the scanning module for scanning the calibration sheet do not overlap.

17. The method according to claim 13, further comprising the steps of:
transporting the original across a scan window, in which the scanning module scans the original.

18. The method according to claim 17, wherein the calibration sheet is located outside the scan window.

19. The method according to claim 13, further comprising the step of:
moving the scanning module to scan the original.

20. The method according to claim 13, wherein the calibration database comprises one of a function and a look-up table.
